(19) United States
(12) Patent Application Publication
(10) Pub. No.: US 2009/0228295 A1
(43) Pub. Date: Sep. 10, 2009

(54) Method for automatically establishing an identification theft recovery service based on the purchase of an item

(76) Inventor: Stephen Lowy, Highland Park, IL (US)

Correspondence Address: Valauskas & Pine LLC, 150 South Wacker Drive, Suite 620, Chicago, IL, 60606, US

(21) Appl. No.: 12/322,847

(22) Filed: Feb. 6, 2009

Related U.S. Application Data
(60) Provisional application No. 61/065,090, filed on Feb. 8, 2008.

(51) Int. Cl. G06Q 99/00

(52) U.S. Cl. 705/1

(57) ABSTRACT

A method for automatically establishing an identification theft recovery service and/or credit fraud recovery service from a company that provides such services relating to identification theft and/or credit fraud, when an individual purchases an item and receives a record of the purchase such as a receipt, which may or may not be related to the protection of an individual's identification or against credit fraud. The identification theft recovery service and/or credit fraud recovery service is automatically initiated upon the purchase of the item without the individual registering or taking any further action. The individual need only keep a proper record of the purchase, and if the individual's identification is stolen or misappropriated and/or becomes the victim of credit fraud, the individual can provide the proper record to receive that company's identification theft recovery services and/or credit fraud recovery services.

### FIELD OF THE INVENTION

This invention relates to an identification theft or credit fraud recovery service that is automatically implemented upon the purchase of an item, and in particular, this invention relates to an identification theft or credit fraud recovery service for issues of identification theft or credit fraud in which the purchaser of an item related to identity theft, such as a paper shredder, or an unrelated item such as a refrigerator, receives proof of purchase, such as a receipt, and automatically acquires an identification theft or credit fraud recovery service without taking any additional steps besides the purchase of the item, and if the purchaser's identity is stolen or his credit is fraudulently misappropriated, or otherwise illegally used, the purchaser will receive the recovery services upon providing proof of the purchase.

### BACKGROUND OF THE INVENTION

The identification of a particular individual can take many forms, including one's social security number or portions of that number, driver's license number, home or business address, telephone number, even the ubiquitous “mother's maiden name,” among others. Further, an individual's records or accounts, either physical or electronic, usually are associated with the individual's identification, so in order to access the records or accounts, the individual must provide the information to the custodian of the records or accounts.

In many instances, when the accounts are established, the account owner generates a key, code word, or a login and password, so that when the owner wishes to access the account, he or she can verify that it is, in fact, his or her account. Using a code allows the individual to access the account without unnecessarily divulging sensitive information each time the account is accessed. Once the login and password are established, the individual can access his or her records by telling the custodian of the account the correct login and password. If correct, the individual gains access to those records or accounts.

This procedure has become widely used especially due to the advent of the Internet and the numerous accounts that an individual may have and can access over the Internet. Although an individual can access numerous websites without knowingly divulging any information, there are accounts in which it is much more efficient to set up an account for each time the individual returns to the website. These accounts only require an individual's email address and a password upon returning to the website. Although anyone can access the websites without providing the information, once the email address and password are provided, certain information can be accessed or stored such that it is more convenient each time the website is accessed.

There are also websites in which the individual's confidential or private information may be accessible once the account is established online. These websites may be set up for access to information from an individual's bank account, credit card accounts, accounts at financial institutions, to name a few. Once these online accounts are established, the individual can access his or her private financial records, and even transact business during a session on these websites.

For example, to access an individual's bank account, the individual first establishes an account using information particular to that individual, including a login and password, each which may be a combination of symbols, numbers, letters and/or alphanumeric characters. Once established, the individual accesses the bank's website by entering the bank's URL into a web browser. On the website, the individual enters his or her particular login code. The website then provides a place for the individual to enter his or her particular password. If the login and password are authenticated, that individual can then access his or her private account information, and if necessary perform certain banking functions, such as transferring money to another account, paying bills, and other functions that include moving money from and to the account.

It is extremely important for the individual to keep all of the information about these accounts and any other personal information secret. If this information is divulged, either knowingly or unknowingly, the person receiving the information can cause the individual harm, either financially or damage to one's credit or reputation. This type of illegal access is known as credit fraud, information theft or identification theft which is also known as ID theft, in which a thief illegally and unscrupulously obtains information related to the individual. Once obtained, that information is used to steal from the individual or to obtain credit cards under someone else's identity, or used to obtain credit, or for securing other services including leasing space, obtaining approval for utilities services, cell phone service contracts and more.

There are a number of actions one can take to reduce the likelihood of credit fraud and identity theft, including the use of a shredder to destroy physical records prior to disposing of them from their residence or business, using security software to protect your computer and e-mails, using secure logins and passwords for accessing information, securing all private and sensitive materials and information, and keeping all confidential information private and secret.

Anyone who obtains information that can be used to obtain credit or get access to an individual's login and password in any manner may be able to apply for credit or access the individual's accounts and transact business as though they were that individual. As one of many examples, if a thief were to obtain the individual's login and password for a bank account, that thief can access the account information on the bank's website and transfer money out of the bank account before the individual has knowledge of the transfer.

There are numerous instances in which a thief uses unscrupulous methods to obtain information that can be used to steal someone's credit, apply for credit, or used to access login and password information to allow access to confidential information and even to gain access to the individual's accounts.

In some cases, illegal computer program's or computer viruses can be used to steal or unknowingly record confidential information, including websites, login's and passwords to illegally gain access to private and confidential information. Some thieves and unscrupulous persons may even attempt to infiltrate a computer with viruses that are capable of recording confidential keystrokes without the owner's knowledge, and then transmits that information back to the thief. In essence, the thief uses the owner's own computer as a spy.

In some cases, a thief pretends to be the individual's bank requesting information, a process known as phishing, and the unsuspecting individual provides the information directly to the thieves. In another practice, a thief will rummage through an individual's garbage left outside the house to find the necessary information. This practice has become so well known and successful that it has spawned its own name, Dumpster Diving.

An individual may also unknowingly load software on the individual's computer that tracks the individual's keystrokes, thereby illegally obtaining the confidential information. In another routine, an individual will be told that a particular situation has occurred and there is money that needs to be transferred to a bank account, and that if that individual provides the information about their bank account, they will transfer the money. If the individual provides the thief the information requested, the thief then uses the information to access the individual's bank account to steal money.

Once a thief has stolen the individual's information and used it to make purchases or transfer money, the individual has a difficult time establishing that it was not him or her that actually made the purchase or transferred the money. In many cases, the individual may be obligated for some or all of the cost, which may cost thousands of dollars and may adversely affect the individual's credit. Often, once an individual's identity is stolen, it could take months or years to recover the money, if it can be recovered, and it often takes even longer to restore the individual's good credit.

In order to safeguard an individual's private and confidential information, the individual must divulge information only when necessary, and only to the proper recipients. This is especially pertinent when providing information over the Internet to recipients for whom the individual has no personal knowledge.

Many safeguards have been created or put in place on websites, at home and in businesses to protect all of this confidential information from being improperly divulged or stolen. Some of these safeguards include software to protect an individual and especially an individual's computer from those trying to deceptively and dishonestly gain access to that information, security envelopes to hide information from thieves searching mailboxes for information and even the use of shredders, which have been marketed in order to completely eradicate confidential information on documents prior to being discarded from a business or even one's home.

In fact, an entire industry has been created to protect individuals from identification theft and assisting individuals once an identification theft has occurred. These companies usually provide their services for an annual or monthly fee. In many cases, an individual registers or purchases the company's services and if their identification is stolen, the company (or its partner or agent) provides an identification recovery service. These services, much like an insurance policy, are difficult to sell without advertising and marketing the services and products to the general public. Further, in many instances the company providing the service must pay an agent to sell the service. It would be advantageous to incorporate a new process for automatically establishing an identification recovery service and/or credit fraud recovery service, without the need for an individual to register for the service, whenever an individual purchases a particular item, which might or might not include the purchase of an item that can be used for protecting an individual from identification theft.

### SUMMARY OF THE INVENTION

The present invention relates to a method for automatically establishing an identification recovery service and/or credit fraud recovery service, from a company that provides such services relating to identification theft and/or credit fraud, based on the purchase of an item. The policy is automatically initiated upon the purchase of the item, without the need for registration or any other action by the individual. The individual need only keep a proper record of that particular purchase, such as the receipt, and if the individual's identification is stolen or misappropriated or if that person is the victim of credit fraud, the individual can provide the proper record to the company to receive that company's identification recovery and/or credit fraud recovery or theft services.

It is an object of the present invention to provide a method for automatically establishing an identification recovery service, from a company that provides such services relating to identification theft and/or credit fraud, when an individual purchases an item.

It is an object of the present invention to provide a method for automatically establishing an identification recovery service and/or credit fraud recovery service, with a waiting period for the service to be available, and for a limited amount of time, which may or may not be based upon the purchase price of an item, from a company that provides such services relating to identification theft and/or credit fraud, when an individual purchases an item.

It is another object of the present invention to provide a method for automatically establishing an identification recovery service and/or credit fraud recovery service, from a company that provides such services relating to identification theft and credit fraud, when an individual purchases an item that is related to the protection from information theft, identification theft and/or credit fraud.

It is another object of the present invention to provide a method for automatically establishing an identification recovery service and/or credit fraud recovery service, from a company that provides such services relating to identification theft and/or credit fraud, when an individual purchases an identification theft kit or bundle, including, but not limited to, one or more of the following items: a paper shredder, anti-virus software, a book on protecting one from identification theft, a non-erasable pen, a virtual shredder, a physical key for protecting one's identification, a personal safe, etc.

It is another object of the present invention to provide a method for automatically establishing an identification recovery service and/or credit fraud recovery service, from a company that provides such services relating to identification theft and/or credit fraud, when an individual purchases a paper shredder.

It is another object of the present invention to provide a method for automatically establishing an identification recovery service and/or credit fraud recovery service, from a company that provides such services relating to identification theft and/or credit fraud, when an individual purchases anti-virus software.

It is another object of the present invention to provide a method for automatically establishing an identification recovery service and/or credit fraud recovery service, from a company that provides such services relating to identification theft and/or credit fraud, when an individual purchases an item that is unrelated to the protection from identification theft and/or credit fraud, such as a refrigerator or an automobile.

### BRIEF DESCRIPTION OF THE DRAWINGS

FIG. 1 is a flow chart indicating the steps for automatically providing an identification theft recovery service and/or credit fraud recovery service in accordance with the preferred embodiment of the present invention;

FIG. 2 is a front view of an identification theft kit in accordance with the preferred embodiment of the present invention.

### DESCRIPTION OF THE PREFERRED EMBODIMENTS

The present invention relates to a method for automatically establishing an identification recovery service and/or credit fraud recovery service from a company that provides such services, relating to identification theft or ID theft and/or credit fraud, when an individual purchases an item, and receives a proof or record of that purchase, such as a receipt. The purchased item may or may not be related to protecting an individual from identification theft and/or credit fraud. The policy is automatically initiated upon the purchase of the item without the need for registration or any further action by the individual, except that the individual need only keep a proper record of the purchase.

If the individual's identification is stolen or misappropriated or his credit has been illegally used by another party, the individual can provide the proper record, such as the receipt, to the company to receive that company's identification theft services or credit fraud recovery service. The company's recovery services for identification theft and credit fraud may include, but are not limited to, investigating the identity theft and/or credit fraud, assisting with contacting and reporting the theft to the police department or other agencies, reimbursing the individual for any monetary loss, contacting the necessary credit bureaus in an attempt to prohibit the downgrading or changing of the individual's credit, contacting the individual's various credit card companies to temporarily stop the use of those credit cards by others, contacting other companies or businesses that grant credit or offer services on terms, such as cell phone companies, stores, local, regional, private and public utilities and others to notify them of identity theft or credit fraud or to assist in protecting the individual and helping to end the abuse against the individual, and contacting the individual's banks and other financial institutions to temporarily stop bank checks and/or financial transactions where necessary to protect the individual, among other services.

Reimbursements may be made for some or all of the following, among others: lost wages, lawyers' fees, travel expenses, the costs for re-filing applications for loans, grants, and credit instruments, the costs for notarizing documents, and additional credit reports.

Once contacted and provided the proper records for the identification theft services and/or credit fraud services, the company may offer additional services or to extend the duration of the services for a fee. Further, there may be a waiting period, for example 30 days, from the time of the purchase until the services can be provided. This waiting period may be necessary to assure that the purchase was not made after the theft occurred.

The identification recovery service and or credit fraud recovery service can be as narrow or broad as necessary, to include some or all of the services provided by the insurance company. For instance, the policy may be limited to a time period from the purchase date, such as six months or a year. This time frame may or may not be based upon the purchase price of an item. Thus, if the individual's identification is stolen within that time frame, the policy will take effect. Further, when the individual makes the purchase, he or she may receive information about the company providing the insurance in order to allow the individual to expand the coverage time or capabilities. However, the individual will receive the identification theft services whether or not they contact the company at the time of the initial purchase.

The item purchased may be related to the protection of an individual's identification or to protect an individual from credit fraud, although the item need not be so related. For instance, when an individual purchases a paper shredder, for shredding documents containing confidential information prior to discarding or recycling, the policy may be initiated. Or, if the individual purchases anti-virus software to protect his or her computer from unwanted and illegal downloads or access to the computer. These are just two of the many examples.

Although the purchase may be related to protecting an individual from identification theft and/or credit fraud, there is no limitation that the purchase must be so related. As such, when an individual purchases a new refrigerator or a new automobile, the identification theft and/or credit fraud policy may be initiated.

The method of the present invention is initially set up either by a company that provides identification recovery services and/or credit fraud services after an individual's identification and/or credit has been stolen or misappropriated, or by another company that distributes a particular item that may or may not be related to the protection of an individual's identification or confidential documents or against credit fraud. For example, if a company sells paper shredders, that company can work with a company that provides identification recovery services and/or credit fraud recovery services and a portion of each shredder sale can be provided to the identification recovery service and/or credit fraud recovery service company, and that company will then provide the service to any individual that has their identification stolen or misappropriated and/or has been the victim of credit fraud, and can provide the proper record of the purchase. Also, a company that neither provides the services or the items can facilitate the setup so that the purchaser of a particular item obtains the identification theft services and/or credit fraud service if necessary.

As described above, at the time the individual purchases the pertinent item, the identification recovery service and/or credit fraud recovery service is established and, in the preferred embodiment, last for a particular amount of time, such as one year. If, during that time, the individual's identification is not stolen or in other ways misappropriated and/or no credit fraud has occurred, the policy terminates. If, on the other hand, the individual's identification is stolen or otherwise misappropriated or is the victim of credit fraud, then the individual contacts either the company providing the services, the company that has sold the item, the company that has setup the system, or another company altogether, depending on how the process has been implemented. The individual must show the proper record of the purchase, such as the receipt obtained at the time of purchase, and proper identification.

Once the record of the purchase is authenticated and, to the extent necessary, any time limitations are verified, the identification theft services and/or credit fraud services are provided as set forth in the policy. For example, the services company may investigate the theft in order to find the thief or from where the information was misappropriated. The identification theft services company and/or the credit fraud service company may also reimburse the individual for any money actually lost from the theft.

The services company may also take action to protect the individual from further illegal actions. For example, the services company may contact the necessary credit card companies to temporarily stop the use of the individual's credit cards, contact banks and other financial institutions to temporarily stop bank checks and financial transactions where necessary. Also, the company may provide the service of contacting the necessary police departments or agencies to report the theft, or contacting the credit bureaus to prohibit the downgrading of one's credit based on the identification theft or credit fraud.

Once contacted by the individual whose identification has been stolen or who has been the victim of credit fraud, the services company may also wish to offer additional services to the individual for this particular identification theft and/or credit fraud, or to protect the individual from similar identification theft and/or credit fraud in the future.

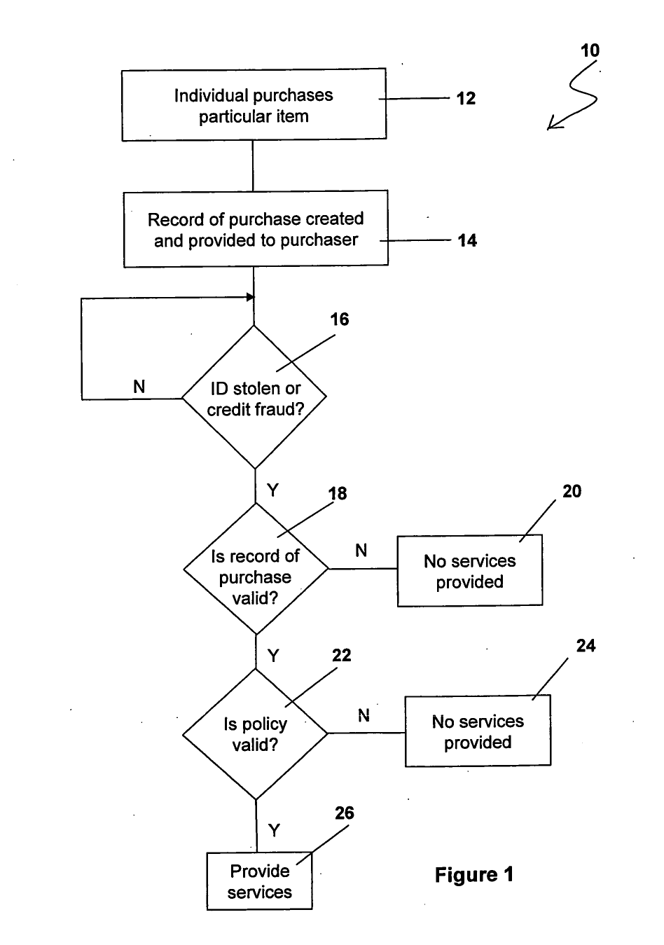

FIG. 1 shows a flow chart of the steps of automatic enrollment into the identification recovery service and/or credit fraud recovery service 10 at the time of the purchase of an item in accordance with the preferred embodiment of the present invention. Initially, the various companies set up the procedures and enter into agreements pertaining to the amount that the services company will receive for providing the identification theft services and/or credit fraud recovery service (not shown). This amount may be based on the number of the items that are sold, or may be a lump sum amount. In effect, the services company receives an amount to provide its services to each and every purchaser of the item (to the extent their identification is stolen or misappropriated and/or that credit fraud has taken place) for a period of time.

The first step 12 of the automatic enrollment 10 occurs when an individual purchases an item. As described above, this item may or may not be related to the protection of the individual's identification and/or against credit fraud. As such, the individual may be purchasing a paper shredder or a refrigerator and the automatic enrollment 10 may apply.

Once the item is purchased 12, a record of the purchase, such as a receipt, is generated and provided to the individual 14. This record can be as simple as a receipt indicating date of purchase, product purchased and the name of the store from which the product was purchased. The record may also be a credit card receipt or a paper or electronic record of an online transaction that contains some or all of the information described above along with a credit card number or the name of the individual purchasing the product. The record may also be a separate document containing some or all of the information described above. Other records or indications that a sale has occurred can be used.

From that point on, nothing occurs unless and until the individual's identification is stolen or misappropriated and/or credit fraud against the individual occurs 16. Depending on whether the individual's identity was actually stolen to illegally transfer funds or whether the individual's identity was misappropriated to create credit for someone else and/or if information was used to charge money to a credit card or to transfer funds from a credit card (credit fraud), the company may take different approaches or may or may not cover the individual at all. The actual coverage and any limitations can be provided to the purchaser at the time of purchase, or the information can be displayed on the company's website, or disseminated in other ways.

The individual whose identification has been stolen and/or who becomes the victim of credit fraud must then provide the record received at the time of the purchase, and either the company or another party must authenticate the record 18. If the record cannot be authenticated, the identification theft recovery services and/or credit fraud recovery services are not provided 20.

To the extent that the record is authenticated, a check must be performed to see if the recovery service plan has begun, has not been terminated, and is still valid 22. As described above, a waiting period may be used to assure the purchase occurred prior to the identification theft, and a termination may be due to a time limit on the policy, or other factors that have or have not occurred, including the purchase price of an item. If the service plan has terminated then the process ends and the company does not provide the services to the individual 24.

Both the authentication process 18 and the policy termination check 22 can be performed by the company providing the insurance or by a third party, either the company that sold the original product or someone else.

If the record is authenticated 18 and the policy has not terminated 22, the company provides some or all of the above-described identification theft recovery services and/or credit fraud recovery services 26, according to the agreement.

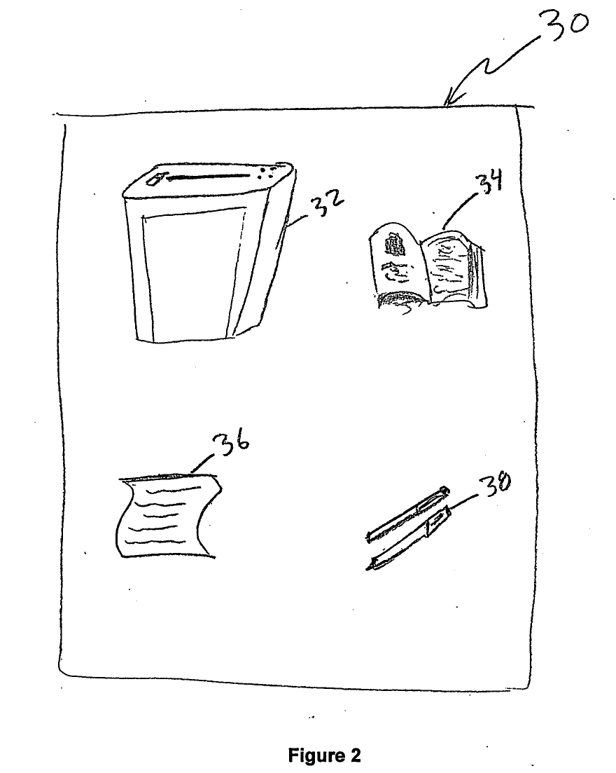

FIG. 2 shows another embodiment of the present invention in which the individual purchases an identification theft protection kit or bundle 30. In the preferred embodiment, the kit 30 contains; a paper shredder 32, a book on preventing identification theft 34, or document describing the identification recovery service and/or the credit fraud recovery service (possibly containing a separate certificate of purchase) 36 and a non-erasable pen 38, which prevents others from erasing portions of a bank check and illegally re-writing the amount and payee of the check.

Similar to the process described above, the purchaser of the kit need only provide the certificate or the receipt of purchase, provided at the time of purchase, in order for the company to provide its identification theft recovery services and/or its credit fraud recovery service (assuming still valid), after a theft or misappropriation of the individual's identification or when credit fraud occurs. The company can then provide the agreed on services.

The described embodiments are to be considered in all respects only as illustrative and not restrictive, and the scope of the invention is, therefore, indicated by the appended claims rather than by the foregoing description. Those of skill in the art will recognize changes, substitutions and other modifications that will nonetheless come within the scope of the invention and range of the claims.

1. A method of automatically establishing an identification recovery service and/or credit fraud recovery service upon the purchase of an item, the steps comprising:
a. Selling an item;
b. Automatically establishing an identification theft recovery service and/or credit fraud recovery service based on the sale of that item;
c. Providing a record of the purchase of that item;
d. Authenticating said record, said authentication establishing an individual that purchased the item and when said purchase occurred, said authentication occurring subsequent to the theft of said individual's identification which can include credit fraud;
e. Determining that said identification theft recovery service and/or credit fraud recovery service is to be provided;
f. Providing identification theft recovery services and/or credit fraud recovery services.

2. The method of automatically establishing an identification theft recovery service and/or credit fraud recovery service upon the purchase of an item in claim 1, wherein the item sold is related to the protection of identification theft.

3. The method of automatically establishing an identification theft recovery service and/or credit fraud recovery service upon the purchase of an item in claim 2, wherein the item sold is a paper shredder.

4. The method of automatically establishing an identification theft recovery service and/or credit fraud recovery service upon the purchase of an item in claim 2, wherein the item sold is software relating to the protection of identification theft and/or credit fraud.

5. The method of automatically establishing an identification theft recovery service and/or credit fraud recovery service upon the purchase of an item in claim 2, wherein the item sold is an identification theft kit.

6. The method of automatically establishing an identification theft recovery service and/or credit fraud recovery service upon the purchase of an item in claim 5, wherein the item sold is a paper shredder.

7. The method of automatically establishing an identification theft recovery service and/or credit fraud recovery service upon the purchase of an item in claim 5, wherein the item sold is a book relating to the prevention of identification theft which may or may not include credit fraud.

8. The method of automatically establishing an identification theft recovery service and/or credit fraud recovery service upon the purchase of an item in claim 5, wherein the item sold is a non-erasable pen.

9. The method of automatically establishing an identification theft recovery service and/or credit fraud recovery service upon the purchase of an item in claim 1, wherein the item sold is not related to the protection of identification theft or credit fraud.

10. The method of automatically establishing an identification theft recovery service and/or credit fraud recovery service upon the purchase of an item in claim 1, wherein the record is a receipt of the purchased item.

11. The method of automatically establishing an identification theft recovery service and/or credit fraud recovery service upon the purchase of an item in claim 1, wherein the record is a certificate of the insurance policy.

12. The method of automatically establishing an identification theft recovery service and/or credit fraud recovery service upon the purchase of an item in claim 1, wherein the record is a credit card receipt.

13. The method of automatically establishing an identification theft recovery service and/or credit fraud recovery service upon the purchase of an item in claim 1, wherein the identification theft recovery services and/or credit fraud recovery service comprises investigating the theft in order to find the thief.

14. The method of automatically establishing an identification theft recovery service and/or credit fraud recovery service upon the purchase of an item in claim 1, wherein the identification theft recovery services and/or the credit fraud service comprises investigating the theft in order to find where the information was misappropriated.

15. The method of automatically establishing an identification theft recovery service and/or credit fraud recovery service upon the purchase of an item in claim 1, wherein the identification theft recovery services comprises reimbursing the individual for any money actually lost from the theft.

16. The method of automatically establishing an identification theft recovery service and/or credit fraud recovery service upon the purchase of an item in claim 1, wherein the identification theft recovery services comprises taking action to protect from any continuing improper actions.

17. The method of automatically establishing an identification theft recovery service and/or credit fraud recovery service upon the purchase of an item in claim 1, wherein the taking action to protect from any continuing improper actions, includes contacting credit card companies to temporarily stop the use of credit cards.

18. The method of automatically establishing an identification theft recovery service and/or credit fraud recovery service upon the purchase of an item in claim 1, wherein taking action to protect from any continuing improper actions, includes contacting financial institutions to stop financial transfers.

19. The method of automatically establishing an identification theft recovery service and/or credit fraud recovery service upon the purchase of an item in claim 1, wherein the identification theft recovery services and/or credit fraud recovery service comprises contacting credit bureaus to prohibit the downgrading of said individual's credit based on the identification theft.
